(19) United States
(12) Patent Application Publication
(10) Pub. No.: US 2004/0128298 A1
(43) Pub. Date: Jul. 1, 2004

(54) Information processing apparatus

(75) Inventors: Masaki Shimada, Tokyo (JP); Kunio Nakano, Tokyo (JP)

Correspondence Address: COHEN, PONTANI, LIEBERMAN & PAVANE, 551 FIFTH AVENUE, SUITE 1210, NEW YORK, NY, 10176, US

(73) Assignee: Konica Minolta Holdings, Inc., Tokyo (JP)

(21) Appl. No.: 10/735,316

(22) Filed: Dec. 11, 2003

(30) Foreign Application Priority Data
Dec. 18, 2002 (JP) 2002-366232

(51) Int. Cl. G06F 17/00

(52) U.S. Cl. 707/100

(57) ABSTRACT

This invention provides an information processing apparatus capable of reliably transferring necessary information while using a general-purpose interface. In the information processing apparatus, a first CPU (16) transmits the first command to a second CPU (22) and then transmits the second command different from the first command. When a response to the second command is sent back from the second CPU (22), the first CPU (16) determines that data transfer from a memory card to an MO disk ends. Commands stocked in a cache (24) are executed in the stock order. When a response to the second command is sent back, the first CPU (16) can determine that the previously stocked first command has been executed.

### BACKGROUND OF THE INVENTION

1. Field of the Invention

The present invention relates to an information processing apparatus and, more particularly, to an information processing apparatus capable of inserting/removing a plurality of recording media and transferring electronic information from one inserted recording medium to another recoding medium.

2. Description of the Prior Art

An image photographed by an electronic camera such as a digital still camera is recorded as electronic information such as an image file (to be simply referred to as a file hereinafter) on a recording medium (e.g., memory card) inserted in the camera. The recorded electronic information is transferred to a personal computer or the like and utilized. Many electronic cameras form file systems similar to one by a personal computer on recording media so as to facilitate data processing in transfer, and generally record each photographed image as one file (see Japanese Unexamined Patent Publication No. 11-164234).

Memory cards and the like put importance on portability, and most of them are formed in, e.g., a postage stamp size and generally have a small recording capacity. As an electronic camera continues photographing, the remaining recording capacity of the memory card decreases, failing in photographing in a short time. To prevent this, a file recorded on the memory card is recorded (copied) on another recording medium. The file in the memory card can be deleted, and photographing can be newly started using the same memory card.

As a general method of transferring a file in one recording medium to another recording medium, a file is read out from an electronic camera to a personal computer or the like via a USB (Universal Serial Bus) or the like, and written in another larger-capacity recording medium such as a hard disk or CD-R. This is called file backup.

To back up a file in a memory card, the user must operate a personal computer to copy the file. File backup is therefore cumbersome. To solve this, a dedicated device which reads out a file in a memory card and writes the file in another recording medium may be prepared. The dedicated device can omit cumbersome operation, but lowers versatility and degrades the product value.

Under the present circumstance, there has been developed an information processing apparatus capable of directly transferring electronic information from one recording medium to another recording medium by one motion of pressing, e.g., a copy button without the mediacy of any external device while maintaining versatility of enabling connection to an external device such as a personal computer.

In constituting such information processing apparatus, the first unit which reads out/writes information from/in one recording medium and the second unit which reads out/writes information from/in another recording medium preferably internally communicate with each other via an existing interface such as ATAPI (ATA Packet Interface) or SCSI (Small Computer System Interface). This is because development and mass production of a unit having a new interface require high cost and a long time and which of new interfaces becomes mainstream cannot be determined at present.

An existing interface such as ATAPI or SCSI generally exhibits a higher transfer rate than the write speed of information on, e.g., an MO disk. To maximize this feature, a high-speed recordable semiconductor memory called a cache is formed in the second unit when information is transferred from the first unit to the second unit. Transferred information is temporarily stocked in the cache, and after the information is written in an MO disk, the information in the cache is deleted. According to this method, even if information is transferred from the first unit to the second unit, information to be written in an MO disk may remain in the cache. At this time, if the user erroneously removes the MO disk, information to be written may be permanently lost. To prevent this, the first unit must determine whether information has been written in the MO disk. In the use of a general-purpose interface such as ATAPI or SCSI, it is difficult for a general-purpose communication protocol to transfer special information such as the completion of writing information on an MO disk. Hence, demands have arisen for a method of transferring the completion of writing information on an MO disk.

### SUMMARY OF THE INVENTION

The present invention has been made to overcome the conventional drawbacks, and has as its object to provide an information processing apparatus capable of reliably transferring necessary information while using a general-purpose interface.

To achieve the above object, the first aspect of the present invention provides an information processing apparatus having a first insertion/removal portion capable of inserting/removing a first recording medium and at least reading out electronic information from the inserted first recording medium, a second insertion/removal portion capable of inserting/removing a second recording medium and reading out and writing electronic information from and in the inserted second recording medium, and an operating member which is connected to the first and second insertion/removal portions so as to be able to exchange electronic information and starts an operation of reading out electronic information recorded on the first recording medium and writing the electronic information in the second recording medium, comprising a first control unit which controls the first insertion/removal portion, a cache which stocks electronic information to be written before the electronic information is written in the second recording medium, and a second control unit which transfers information to the first control unit via a predetermined interface and controls the second insertion/removal portion and the cache, wherein the first control unit reads out electronic information from the first recording medium inserted in the first insertion/removal portion in accordance with an operation to the operating member and transmits the read electronic information to the second control unit together with a first command to request write of the read electronic information in the second recording medium, the second control unit stocks in the cache the electronic information which has been transmitted from the first control unit and executes the first command in a stock order to record the electronic information on the second recording medium, the first control unit transmits a second command different from the first command after transmitting all pieces of electronic information to be recorded to the second control unit, and the first control unit determines that transfer of the pieces of electronic information from the first recording medium to the second recording medium has completed when a response to the second command is sent back from the second control unit.

The first command stocked in the cache is executed in the stock order. Thus, when a response to the second command is sent back, the previously stocked first command can be determined to have been executed. Even in the use of a general-purpose interface such as ATAPI or SCSI, the completion of writing data in the second recording medium can be grasped in real time. The predetermined interface can communicate information by a predetermined communication protocol such as SCSI or ATAPI.

The second aspect of the present invention provides an information processing apparatus, further comprising an expression unit which expresses an end of transfer from the first recording medium to the second recording medium.

The user can be notified of the completion of writing information in the second recording medium.

The third aspect of the present invention provides an information processing apparatus wherein the expression unit includes a display device, and expression operation includes transfer of a visual message to a user.

The user can understand the status at a glance.

The fourth aspect of the present invention provides an information processing apparatus wherein the display device includes a monitor which displays a message.

Accordingly, complicated information can be transferred.

The fifth aspect of the present invention provides an information processing apparatus wherein the display device includes an LED.

The information processing apparatus can be manufactured at low cost without any space.

The sixth aspect of the present invention provides an information processing apparatus wherein the expression unit includes a sound generating device, and expression operation includes transfer of an auditory message to a user.

The user can receive a message even if not gazing at the information processing apparatus.

The seventh aspect of the present invention provides an information processing apparatus wherein the sound generating device includes a loudspeaker.

The eighth aspect of the present invention provides an information processing apparatus wherein removal of the second recording medium is permitted in accordance with an end of transfer from the first recording medium to the second recording medium.

This can prevent a trouble such as removal of the recording medium during write of electronic information.

According to the present invention, even in the use of a general-purpose interface such as ATAPI or SCSI, the completion of writing information in an MO disk can be grasped in real time.

In this specification, the first recording medium is preferably an optical information recording medium (e.g., memory card, CD-R, or DVD-R), or a magnetooptical information recording medium (e.g., MO). The second recording medium is preferably an optical information recording medium (e.g., CD-R or DVD-R), a magnetooptical information recording medium (e.g., MO), or a hard disk. The second recording medium is preferably larger in capacity than the first recording medium. The control unit can preferably create a file system in the second recording medium by formatting or the like. The information processing apparatus preferably comprises a display unit and/or sound generating unit representing the transmission/reception state of image information. Electronic information includes an image file, but is not limited to this and includes various data such as document data and CG data. The first insertion/removal portion may be equipped with a port such as a USB port, and connected to a digital still camera or another storage device instead of the first recording medium.

The above and many other objects, features and advantages of the present invention will become manifest to those skilled in the art upon making reference to the following detailed description and accompanying drawings in which preferred embodiments incorporating the principle of the present invention are shown by way of illustrative example.

### BRIEF DESCRIPTION OF THE DRAWINGS

FIG. 1 is a schematic perspective view showing an external MO drive apparatus as an embodiment of an information processing apparatus according to the present invention;

FIG. 2 is a functional block diagram showing the MO drive apparatus in FIG. 1; and

FIGS. 3A and 3B are a series of ladder charts showing control operation of the MO drive apparatus in FIG. 1.

### DETAILED DESCRIPTION OF THE PREFERRED EMBODIMENT

A preferred embodiment of the present invention will be described below with reference to the accompanying drawings.

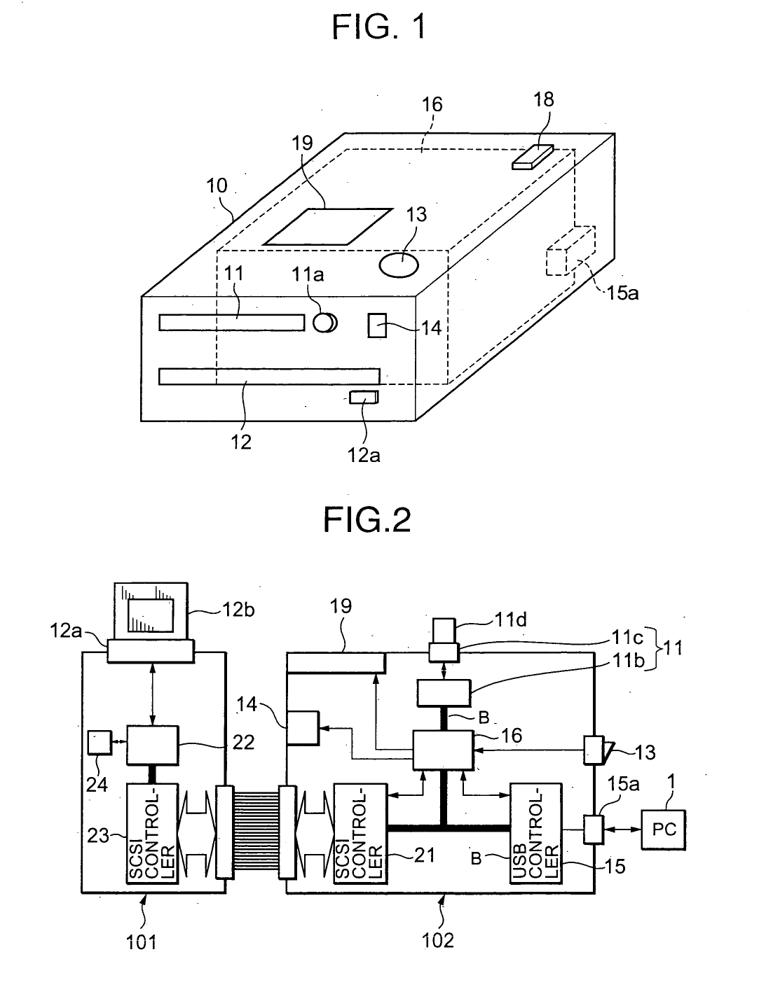

In FIG. 1 showing an external MO drive apparatus as the embodiment of the present invention, the front surface of a housing 10 is equipped with a memory card slot 11 for a PC card or the like serving as the first insertion/removal portion, an MO disk slot 12 serving as the second insertion/removal portion, and an LED 14 serving as a display unit. The back surface of the housing 10 is equipped with a USB connector 15a serving as a connection portion to a personal computer or the like. The upper surface of the housing 10 is equipped with a monitor 19 serving as an expression unit (e.g., a display device), a copy button 13 serving as an operating member, and a power switch 18. An eject button 11a for ejecting an inserted memory card (e.g., PC card) with an adaptor is arranged on the side of the memory card slot 11. An eject button 12a for ejecting an inserted MO disk is arranged below the MO disk slot. 12. A control unit 16 receives an ON signal from the copy button 13 to detect that the copy button 13 has been operated.

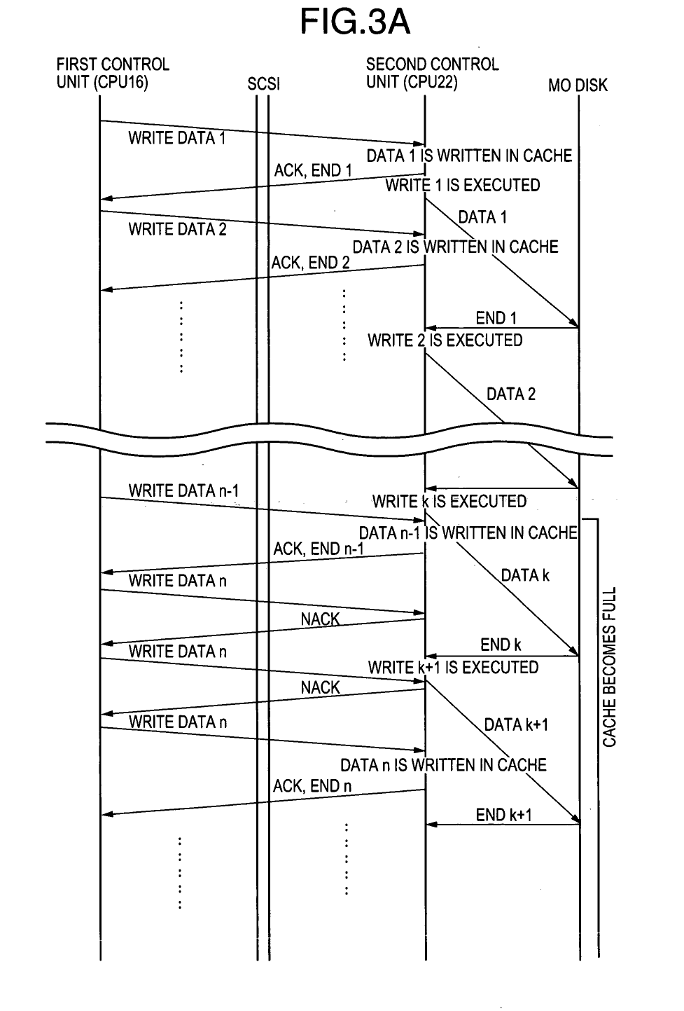

FIG. 2 is a functional block diagram showing the external MO drive apparatus. The external MO drive apparatus is comprised of an MO drive unit 101 and card drive unit 102. Information is transferred between the MO drive unit 101 and the card drive unit 102 by using a SCSI interface or the like.

More specifically, in the card drive unit 102, the first control unit (first CPU) 16 is connected, via bus B so as to be able to transfer information, to the memory card slot 11 (including a memory card connector 11c and card control IC 11b) capable of reading out or writing electronic information from or in a memory card 11d with an adaptor when the memory card 11d is inserted, a USB controller 15 having the USB connector 15a capable of connecting an external personal computer 1, and a SCSI controller 21. The first CPU 16 receives a signal from the copy button 13, displays information (message) on the monitor 19, and ON/OFF-controls the LED 14.

In the MO drive unit 101, a second control unit (second CPU) 22 is connected to a SCSI controller 23 capable of transferring information to the SCSI controller 21 in accordance with the SCSI protocol, a cache 24, and the MO disk pickup device (constituting the second insertion/removal portion) 12a capable of reading out or writing electronic information from or in an MO disk 12b when the MO disk 12b is inserted.

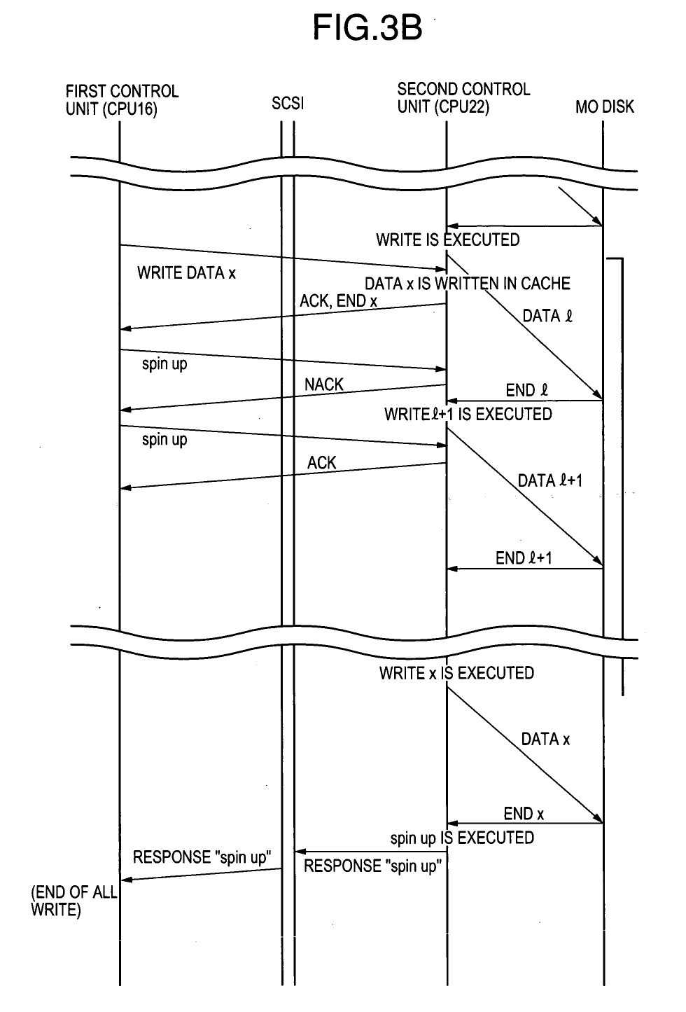

A method of transferring electronic information from the memory card 11d to the MO disk 12b via the external MO drive apparatus will be explained with reference to a series of ladder charts shown in FIGS. 3A and 3B.

An example of reading out x data (electronic information) from the memory card 11d and writing the data in the MO disk 12b will be described.

The first CPU 16 accesses the memory card 11d via the card control IC 11b, and reads out the first data. The first CPU 16 issues a write command (first command complying with the SCSI protocol) to write the first data, and transmits the first data and write command via the SCSI controller 21. Upon reception of the first data and write command via the SCSI controller 23, the second CPU 22 transmits via the SCSI controller 23 information (ACK information) that the first data and write command have normally been received, and stocks the first data and write command in the cache 24. Since the communication speed via the SCSI interface is higher than the write speed of the MO disk 12b, communication between the MO drive unit 101 and the card drive unit 102 can be quickly completed by stocking the first data and write command in the cache 24.

When the first data and write command are stocked in the cache 24, the second CPU 22 transmits via the SCSI controller 23 information (write end information) that stock operation has been completed. The second CPU 22 starts writing the first data in the MO disk 12b via the MO disk pickup device 12a. Since data can be instantaneously stocked in the cache 24, ACK information and write end information are almost simultaneously sent back.

Upon reception of the write end information on the first data transmitted by the second CPU 22, the first CPU 16 issues a write command to write the second data which has already been read out by accessing the memory card via the card control IC 11b, and transmits the write command together with the second data via the SCSI controller 21. Upon reception of the second data and write command via the SCSI controller 23, the second CPU 22 transmits via the SCSI controller 23 information (ACK information) that the second data and write command have normally been received, and stocks the second data and write command in the cache 24. Stock and write are performed by the same sequence until the cache 24 becomes full (i.e., the free space decreases and data cannot be stocked). Stocked commands are executed in the stock order.

If the cache 24 becomes full upon stocking the (n−1)th data and write command, the second CPU 22 sends back information (NACK information) that the nth data and write command have not normally been received, via the SCSI controller 23 upon reception of the nth data and write command, thereby denying the command. To the contrary, the first CPU 16 keeps transmitting the nth data and write command until the second CPU 22 transmits ACK information. If the cache 24 ensures a sufficient free space by writing stocked data k in the MO disk and deleting the data k, the second CPU 22 receives the nth data and write command, and sends back ACK information and write end information, as shown in FIG. 3A. In this manner, when data much larger in amount than the capacity of the cache 24 is transmitted to the MO drive unit 101 and the cache 24 becomes full, the data transfer rate is changed in accordance with the write speed of the MO disk.

Upon reception of write end information on the xth data transmitted by the second CPU 22, the first CPU 16 issues a dummy command (in this case, spinup command serving as the second command for spinning an MO disk), and transmits the dummy command via the SCSI controller 21 (see FIG. 3B). In this case, if the second CPU 22 determines that the cache 24 becomes full and overflows, the second CPU 22 transmits via the SCSI controller 23 information (NACK information) that the data has not normally been received. If the cache 24 becomes sufficiently free, the second CPU 22 stocks the spinup command in the cache 24 via the SCSI controller 23.

At this time, if data to be written in the MO disk remains in the cache 24 and write is kept executed, the spinup command is not executed and is kept stocked in the cache 24. The spinup command is executed only after write of x data is completed. Since the MO disk has already spun, the second CPU 22 transmits as a response via the SCSI controller 23 information (invalid information) that the spinup command is invalid. Upon reception of the invalid information transmitted by the second CPU 22, the first CPU 16 can determine that the spinup command has been executed, i.e., all data stocked in the cache are written in the MO disk.

The first CPU 16 which has determined that all data to be transferred in the memory card have been written in the MO disk can display on, e.g., the monitor 19 a message (including a character and icon) that data transfer has been completed. If the MO disk has an eject mechanism, control of permitting eject can be done. Instead of display on the monitor 19 serving as a display device, the LED 14 may be flickered to represent the progress of data transfer, or the LED 14 may be turned off to express that electronic information can be transferred. In this case, the LED 14 functions as a display device. In this way, the message that data transfer has been completed can be visually transferred to the user.

As another embodiment, a loudspeaker (not shown) may be installed as a sound generating device serving as an expression unit. In this case, the completion of transferring electronic information may be expressed by generating a long sound once, or a message to this effect may be expressed by voice. The message that data transfer has been completed can be auditorily transferred to the user.

The present invention has been described by referring to the embodiment shown in the accompanying drawings. However, the present invention should not be restrictively interpreted to the above embodiment, and can be properly changed and modified. For example, the interface is not limited to SCSI, and may be ATAPI. The second command need not be a spinup command, but may be an eject command as far as the second command is distinguished from the first command and a response from the second CPU 22 is a predetermined command. Further, a message may be expressed to the user by using a video/audio output unit, an external monitor as a display device, and an external loudspeaker as a sound generating device.

What is claimed is:

1. An information processing apparatus having a first insertion/removal portion capable of inserting/removing a first recording medium and at least reading out electronic information from the inserted first recording medium, a second insertion/removal portion capable of inserting/removing a second recording medium and reading out and writing electronic information from and in the inserted second recording medium, and an operating member which is connected to the first and second insertion/removal portions so as to be able to exchange electronic information and starts an operation of reading out electronic information recorded on the first recording medium and writing the electronic information in the second recording medium, comprising:
first control means for controlling the first insertion/removal portion;
a cache which stocks electronic information to be written before the electronic information is written in the second recording medium; and
second control means for transferring information to said first control means via predetermined interface means and controlling the second insertion/removal portion and said cache,
wherein said first control means reads out electronic information from the first recording medium inserted in the first insertion/removal portion in accordance with an operation to the operating member and transmits the read electronic information to said second control means together with a first command to request write of the read electronic information in the second recording medium,
said second control means stocks in said cache the electronic information which has been transmitted from said first control means and executes the first command in a stock order to record the electronic information on the second recording medium,
said first control means transmits a second command different from the first command after transmitting all pieces of electronic information to be recorded to said second control means, and
said first control means determines that transfer of the pieces of electronic information from the first recording medium to the second recording medium has completed when a response to the second command is sent back from said second control means.

2. An apparatus according to claim 1, further comprising expression means for expressing completion of transfer from the first recording medium to the second recording medium.

3. An apparatus according to claim 1 or 2, wherein said expression means includes a display device, and expression operation includes transfer of a visual message to a user.

4. An apparatus according to claim 3, wherein the display device includes a monitor which displays a message.

5. An apparatus according to claim 3 or 4, wherein the display device includes an LED.

6. An apparatus according to claim 1 or 2, wherein said expression means includes a sound generating device, and expression operation includes transfer of an auditory message to a user.

7. An apparatus according to claim 6, wherein the sound generating device includes a loudspeaker.

8. An apparatus according to any one of claims 1 to 7, wherein removal of the second recording medium is permitted in accordance with an end of transfer from the first recording medium to the second recording medium.
